(19) United States
(12) Patent Application Publication
(10) Pub. No.: US 2013/0303238 A1
(43) Pub. Date: Nov. 14, 2013

(54) Mini-Projector Apparatus for Combining with Portable Device

(71) Applicants: Shao Hua Huang, Hsin-Chu (TW); Hsin Hung Tu, Hsin-Chu (TW)

(72) Inventors: Shao Hua Huang, Hsin-Chu (TW); Hsin Hung Tu, Hsin-Chu (TW)

(21) Appl. No.: 13/468,380

(22) Filed: May 10, 2012

(51) Int. Cl. H04N 5/74; H04W 88/02; H04M 1/02

(52) U.S. Cl. 455/557; 348/E05.143

(57) ABSTRACT

The present invention provides a mini-projector apparatus for combining with a portable device. The mini-projector apparatus includes a base which is a heat sink. A mini-projector is disposed on the base. A heat conduction medium is disposed between the base and the mini-projector. A top housing is capable of combining with the base such that the mini-projector and the heat conduction medium can be fixed between the base and the top housing. The portable device may be fixed on the top housing.

### TECHNICAL FIELD

The present invention generally relates to a video output system, more particularly, to a mini-projector capable of directly connecting with an audio and video output interface of a mobile phone for projection.

### BACKGROUND

For general video devices (digital video camera or digital camera), after capturing moving or still images from outside, audio and video data will be processing and converting for digitization, and then stored in a memory built within the video devices. The operator can operate to preview dynamic or static images on screen through a display of the video devices. As the captured image data is prepared for the external projection brief, the dynamic or static images data stored in the video devices will be transmitted to a computer by a transmission line. The dynamic or static images data will be processed by the related driver and edition program of the computer for transferring the files and related processing. The computer is connected to a digital projector for playing the dynamic or static images.

Currently, as a projection brief is prepared in the public meeting, you must carry a mobile computer and a digital projector, and thereby the transferred video files of the video device rendering outside projection to show by the digital projector. To complete the projection, the video files need to be filed and stored on the computer, and a mobile computer and a digital projector are required for the digital projection. Processing procedures of conversion and transmission for the digital data are complicated. It is inconvenient for a user due to heavy and more hardware apparatus. Moreover, the conventional video projector is always combined with the computer which applications are monotonous and unchanged.

In addition, the current mini-projector can be applied to smart phones. However, for the smart phone free of built-in micro projector, it needs a signal line to connect with the micro projector for signal communication, and then to project a frame on the screen. When used, such two devices or products shall be independent for applications. For the mini-projector, a light source such as light emitting diode (LED), is passing through and refracting to project to the screen, whereby the electrical energy is converted to light and cause the “heat” to be produced. There is no method for solving the “heat” issue of the mini-projector. When the heat accumulation arising from light emitting diodes (LEDs) activated can not be resolved immediately, it will result in rapid decrease, degradation of the luminous efficiency, power and brightness of light emitting diodes, and thereby causing failure and life-time decreased of the mini-projector. For the heat generated by light-emitting diodes, the temperature can be as high as 85 degrees Celsius or more, and it is harmful for a user as heat dissipation efficiency is not good to result in heat focusing. In order to solve the heat dissipation issue of the mini-projector, a mini-fan may be added. However, the rotation of the mini-fan increases load of the battery, and thus reducing the continuous projection time of the device. In addition, the use of mini-fan will cause noise and electromagnetic interference as the system operates, and thus affecting the electronic components for activating.

Therefore, based-on the shortcomings, the present invention provide a novel mini-projecting system with a heat sink.

### SUMMARY OF THE INVENTION

An objective of the present invention is to provide a mini-projector integrated into a smart phone as a whole structure to reach the purpose of image magnification projection and/or mobile power, wherein the smart phone can be connected to the mini projecting system without processed by a computer.

An objective of the present invention is to provide a mini-projecting system, wherein the heat is directly conducted to the metal bottom cover via the high conductive medium for dissipating to the air, and thereby resolving the issue of the heat generated by the light source of the mini-projector without additional mini fans.

Moreover, the projecting system may provide a backup power automatically charging to the smart phone when connected to the projecting system.

According to an aspect of the present invention, the present invention provides a bottom cover, which is a heat sink. A mini projector is configured on the base. A heat conduction medium is configured between the base and the mini projector. A top cover is capable of combining with the bottom cover to facilitate the mini projector and the heat conduction medium fixing between the top cover and the bottom cover, and the portable device capable of fixing on the top cover.

The top cover comprises a lock portion for locking said portable device. The lock portion has a slide for facilitating the portable device sliding into the lock portion along the slide to fix on the top cover. The top cover further comprises a second lock portion for locking the bottom cover. The bottom cover comprises a fixture for facilitating the mini projector fixing on the bottom cover. The bottom cover comprises a joint focus ring structure which allows for a focus ring of the mini projector.

According to another aspect of the present invention, a gap is located between the mini projector and the bottom cover for the heat conduction media capable of contacting the mini projector and the bottom cover, respectively.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a diagram of a system for a portable electronic device combined with a mini-projector of an embodiment of the present invention;

FIG. 2 illustrates a diagram of the top cover of the base of an embodiment of the present invention;

FIG. 3 illustrates a diagram of the bottom cover of the base of an embodiment of the present invention;

FIG. 4 illustrates a diagram of a base combined with a mini-projector of an embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides a portable electronic device combined with a mini-projector with a system heat sink. For example, the portable electronic device comprises a touch wireless video output device, a mobile phone, a smart phone (such as iPhone), a portable game console, a personal digital assistant (PDA), a notebook or a Tablet PC. By employing system design, a smart phone may be directly integrated on a device structure. The mini projector is embedded in the device structure such that the mini projector and the smart phone are integrated into the device structure as a whole, and thereby increasing the user's convenience. That is, the functions of the mini projector and the mobile phone are integrated into the device structure, and greatly enhancing the portability, convenience and multi-functional use of the mini projector.

In the operation of the mini projector, the light source (such as light-emitting diode) is rapidly accumulated heat, and therefore it needs to the heat drawn out of the light source body quickly. The present provides a metal base design, and make a high conduction medium configured (placed) between the mini-projector and the metal base. A gap is designed between the mini-projector and the metal base, to make the high conductive medium contact to the mini-projector and the metal base. In addition, the micro-projector includes a charging module or mechanism which can charge to the portable device; or mini-projector power supply may be as a backup power supply for providing to the smart phone.

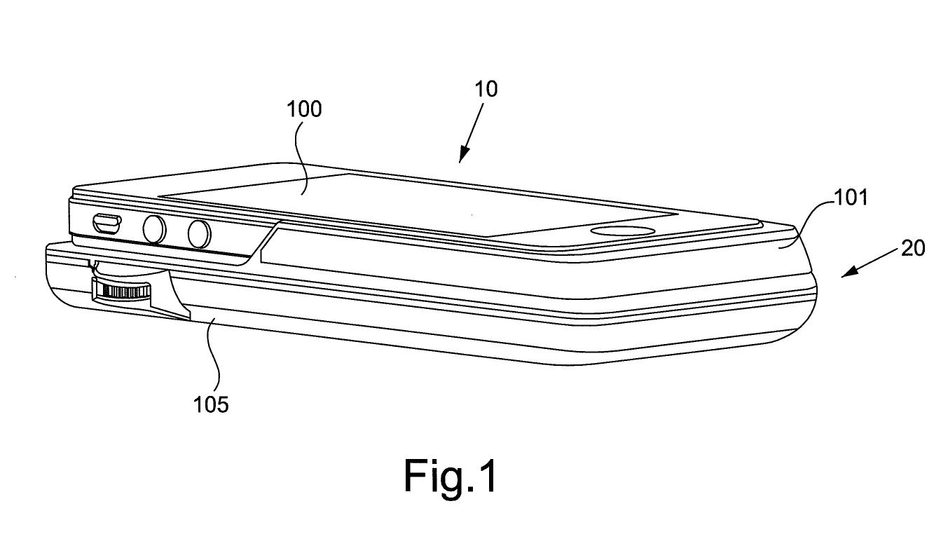

FIG. 1 shows a diagram of a system for a portable electronic device combined with a mini-projector of an embodiment of the present invention. The system 10 for the portable electronic device combined with the mini-projector comprises a portable electronic device 100, a base 20 and a mini projector. For example, the base 20 is constituted by a top cover (housing) 101 and a bottom cover (housing) 105. In one embodiment, the portable electronic device 100 comprises a touch wireless video output device, a mobile phone, a smart phone (such as iPhone), a portable game console, a personal digital assistant (PDA), a notebook or a Tablet PC (such as iPad). In this embodiment, the mini projector is configured into the base 20. The base 20 is designed as a specific feature or structure for facilitating the smart phone 100 fixed thereon such that the smart phone 100 and the mini projector are integrated as a whole system or structure.

In this invention, material of the base 20 comprises carbon nano-tube, metal (such as aluminum) or alloy.

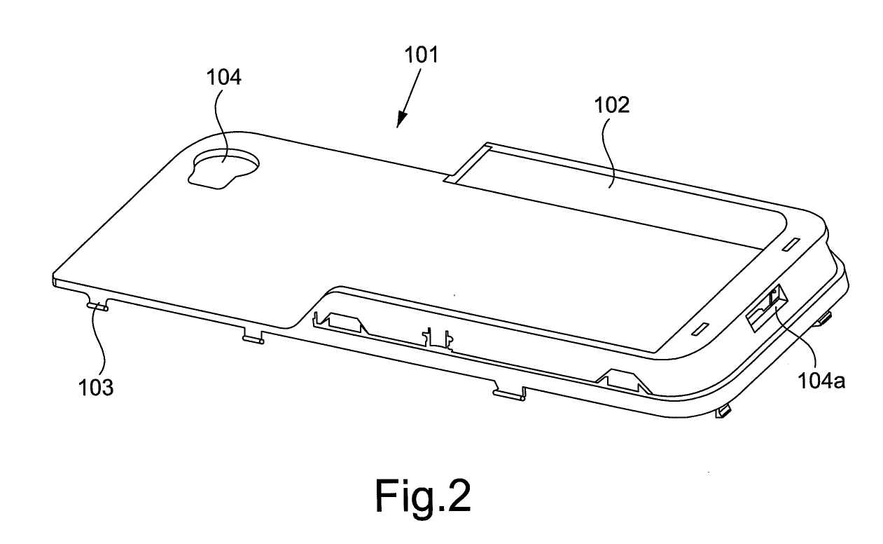

FIG. 2 shows a diagram of the top cover of the base of an embodiment of the present invention. For example, the top cover 101 includes a lock portion 102 for locking the bottom of the smart phone 100 such that the smart phone 100 can be combined and fixed thereon. The lock portion 102 is located above the bottom plane of the top cover 101. The lock portion 102 is for example a U-shaped structure. The lock portion 102 has a slide. The smart phone 100 may be slid to the bottom of the lock portion 102 (U-shaped structure) along the bottom plane of the top cover 101, and both sides (slide) of the lock portion 102, to being fixed on the top cover 101. Therefore, the bottom size of the top cover 101 is slightly larger than that of the smart phone 100. Front edge of the of the lock portion 102 has an opening 104a for exposing a charging interface. As the smart phone 100 combined with the top cover 101, the charging interface is still to be exposed for facilitating charging. The bottom of the top cover 101 can be designed with an opening 104 to for aligning lenses. As the smart phone 100 combined with the top cover 101, the camera lenses of the smart phone 100 can be aligned to the opening 104 to facilitate the smart phone 100 capturing the external video and audio data.

Moreover, the top cover 101 may further comprise another lock portion 103 for locking or combining with the bottom cover 105. The lock portion 103 is located around the top cover 101. The lock portion 103 is for example a plurality of flanges for facilitating to combine with the corresponding groove structure 103a of the bottom cover 105 such that the top cover is combined and fixed with the bottom cover 105.

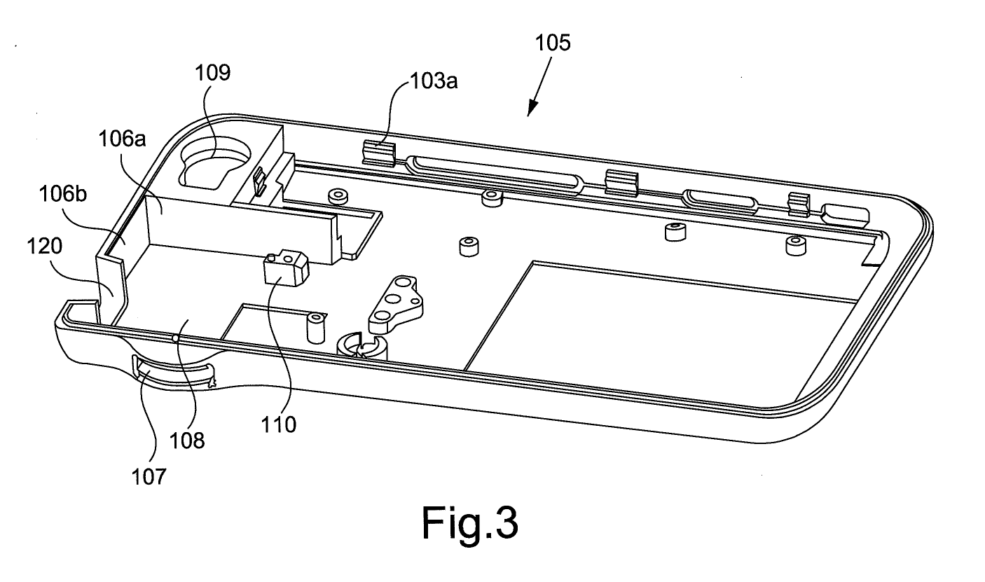

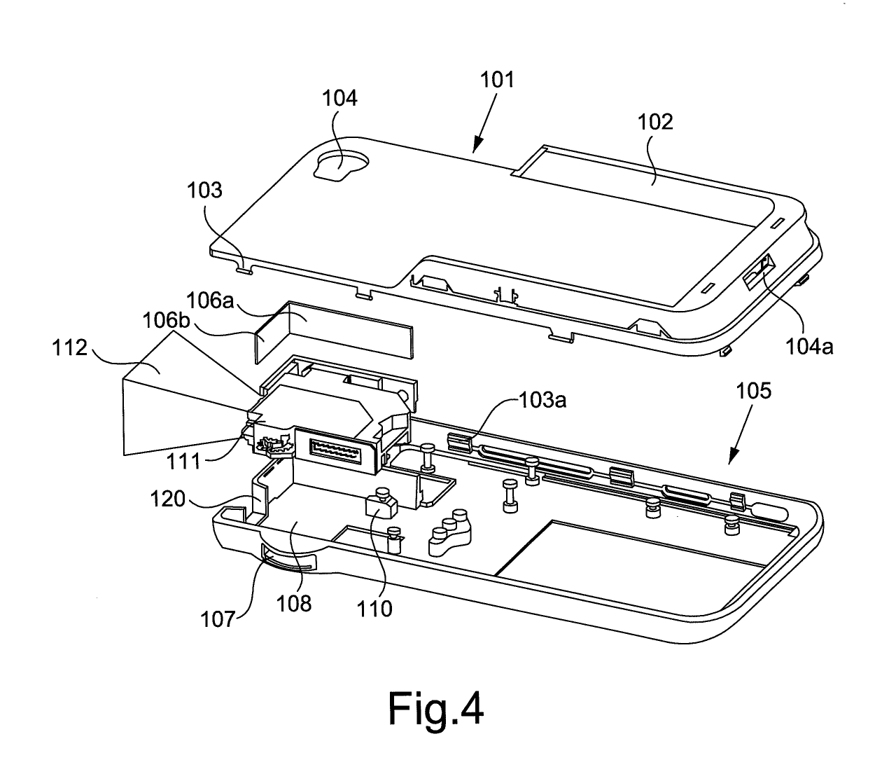

FIG. 3 shows a diagram of the bottom cover of the base of an embodiment of the present invention. The bottom cover 105 is a base plate of the base 20. For example, the bottom portion of the bottom cover 105 has a plurality of lock portions for locking the other required components. Two sides of the bottom cover 105 have some groove structure 103a for facilitating to be locked with the lock portion 103 of the top cover 101. In addition, the bottom of the bottom cover 105 has a space 108 to facilitate a mini projector 111 embedded or placed therein, and a fixture 110 to facilitate mini-projector 111 fixed therein, shown in FIG. 4. The bottom cover 105 is also designed with an opening 109 for aligning the opening 104 of the top cover 101. In addition, the bottom cover 105 is designed with an opening 120 such that projection light of the mini-projector 111 can pass through the optical lens, and then exits from the opening 120 for projecting. The high heat conduction media (106a, 106b) can be configured in the bottom cover 105 close to the mini-projector 111. One side of the bottom cover 105 can be designed with a joint focus ring structure 107 for combining with a focus ring of the mini-projector 111, and thereby facilitating the use of the focus ring.

In one embodiment, the system with heat sink of the present invention comprises a high conductive medium and a heat sink. The high conductive medium is for example a high heat conduction media (106a, 106b), and the heat sink is the bottom cover 105 of the base 20, shown in FIG. 3. For example, the heat conduction medium (106a, 106b) is connected or adjacent to the mini-projector 111 and the bottom cover 105, or configured near the mini-projector 111, for facilitating heat generated by the mini-projector 111 conducting to the heat sink (the bottom cover 105), and followed by dissipating the heat to the outside via the heat sink. In a preferred embodiment, the heat conduction medium (106a, 106b) is disposed near a light source of the mini-projector 111, or attached to (nearly) the light source. For example, material of the heat conduction medium (106a, 106b) comprises heat silicon grease, heat silicone, heat plastic, heat graphite films, heat mica, heat phase change material, metal or alloy, while materials of the heat sink (the bottom cover 105) comprise ceramic, metal or alloy.

From the above description, it should be noted that the mini-projector 111 of the present invention is mechanically fixed on the bottom cover 105 of the base 20. The heat generated by the light source (light emitting diode) of mini-projector 111 is directly conducted to the bottom cover 105 via the high conductive medium (106a, 106b), and followed by the heat dissipating to the air by inherent conduction characteristic of the metal itself.

In one embodiment, the high heat conduction media (106a, 106b) is configured between the mini-projector 111 and the metal bottom cover 105; and there is a gap designed between the mini-projector 111 and the metal bottom cover 105. It ensures that the high heat conduction media (106a, 106b) can contact the mini-projector 111 and the metal bottom cover 105 respectively, in order to facilitate the heat generated by the mini-projector 111 directly conducting to the bottom cover 105 via the high heat conduction media (106a, 106b).

In one embodiment, the mini-projector 111 includes a micro-processing unit, a projection optical engine, a charging module, a battery, a focusing unit and an indicating unit. The focusing unit is capable of adjusting the focal length of the optical lens. The indicating unit is used for indicating the battery power and/or function of switch to facilitate identifying the usage state of the device. For example, the indicating unit comprises a light emitting diode. For example, an output video data of the smart phone 100 may be projected as a video projection image 112 by employing the optical engine. The output image may be magnified or adjusted depending on the actual application or requirement.

In this embodiment, an external power source may be connected to the mini projector 111 for providing electrical power or charging to the mini projector 111. In one embodiment, the charging module may be integrated into the mini projector 111 such that the mini projector 111 becomes a mobile projector with power supply function.

In one embodiment, structure of the mini-projector 111 contains a projection optical engine, a printed circuit board, a battery, a charging interface, a focus ring, an indication light and a charging mode switching key configured in the relative position of the structure of mini-projector. The optical lens can be used to enlarge projected image 112 of the mini projector 111. Light of projection may be projected to the outside through the optical lens. The focus ring is capable of adjusting the focal length of the optical lens. By switching the charging mode, as the mini-projector 111 is electrically connected to the smart phone 100, the battery of the smart phone 100 or the battery of the mini projector 111 is therefore to be charged by activating the charging module.

In one embodiment, the connection mode between the mini projector 111 and the smart phone 100 comprises wireless transmission connection (through the respective device's built-in wireless module for connection) or using a connecting wire (line) to connect.

In addition, the whole base 20 can also be a heat conduction material. That is, the top cover 101 can also be chosen as a material with high thermal conduction as described above.

FIG. 4 shows a diagram of a base combined with a mini-projector of an embodiment of the present invention. The mini-projector 111 and the high heat conduction media (106a, 106b) are configured (embedded) between the top cover 101 and the bottom cover 105. After the top cover 101 is combined with the bottom cover 105 as the base 20, a heat sink system of mini-projection device will be created. Subsequently, the smart phones 100 is fixed on the top cover 101, and the overall structure becomes a dual-use device for mobile phone with projector. Such structure has an excellent heat dissipation mechanism.

As above-mentioned, the system with heat sink for the portable electronic device combined with the mini-projector has at least the following effects:
1. The smart phone and the mini-projector are integrated into a whole structure, which can improve the convenience of the user.
2. The heat generated by the light emitting diode of the mini-projector is directly conducted to the metal bottom cover via the high conductive medium, and the heat may be dissipated to the air by inherent conduction characteristic of the metal itself.
3. The property of the metal base (cover) can directly strengthen the rigidity of the system.
4. The mini fan is replaced directly by the metal base (cover), which can effectively reduce the electrical energy loss due to mini-fan operation, and thus increasing life time of the battery.
5. It may avoid the noise generated in the operation of the mini-fan.
6. The system power may be as a backup power available to the smart phone.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. A mini projection apparatus for combining with a portable device, comprising:
a bottom cover, which is a heat sink;
a mini projector, configured on said base;
a heat conduction medium, configured between said base and said mini projector; and
a top cover, for combined with said bottom cover to facilitate said mini projector and said heat conduction medium fixing between said top cover and said bottom cover, and said portable device capable of fixing on said top cover.

2. The apparatus of claim 1, wherein said top cover comprises a lock portion for locking said portable device.

3. The apparatus of claim 2, wherein said lock portion has a slide for facilitating said portable device sliding into said lock portion along said slide to fix on said top cover.

4. The apparatus of claim 2, wherein said top cover further comprises a second lock portion for locking said bottom cover.

5. The apparatus of claim 1, wherein said bottom cover comprises a fixture for facilitating said mini projector fixing on said bottom cover.

6. The apparatus of claim 1, wherein said bottom cover comprises a joint focus ring structure which allows for a focus ring of said mini projector.

7. The apparatus of claim 1, wherein said portable device comprises a touch wireless video output device, a mobile phone, a smart phone, a portable game console, a personal digital assistant (PDA), a notebook or a Tablet PC.

8. The apparatus of claim 1, wherein a gap is located between said mini projector and said bottom cover for said heat conduction media capable of contacting said mini projector and said bottom cover, respectively.

9. The apparatus of claim 1, wherein material of said bottom cover comprises ceramic, metal or alloy.

10. The apparatus of claim 1, wherein material of said heat conduction medium comprises silicon grease, silicone, plastic, graphite films, mica, phase change material, metal or alloy.
